(19) United States
(12) Patent Application Publication
(10) Pub. No.: US 2020/0290649 A1
(43) Pub. Date: Sep. 17, 2020

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventors: Katsuyasu Yamane, Wako-shi (JP); Yasushi Shoda, Wako-shi (JP); Yuki Hara, Wako-shi (JP); Yoshitaka Mimura, Wako-shi (JP); Junpei Noguchi, Wako-shi (JP); Hiroshi Yamanaka, Wako-shi (JP); Ryoma Taguchi, Tokyo (JP); Yuta Takada, Tokyo (JP); Chie Sugihara, Tokyo (JP); Yuki Motegi, Tokyo (JP); Tsubasa Shibauchi, Tokyo (JP)

(21) Appl. No.: 16/809,620

(22) Filed: Mar. 5, 2020

(30) Foreign Application Priority Data
Mar. 12, 2019 (JP) 2019-045101

(51) Int. Cl. B60W 60/00; B60W 10/30; B60W 50/00

(52) U.S. Cl. CPC B60W 60/00253; B60W 50/0098; B60W 10/30

(57) ABSTRACT

A vehicle control system includes: a recognizer configured to recognize a surrounding environment of a vehicle; a driving controller configured to perform at least one of speed control and steering control of the vehicle according to a recognition result of the recognizer; and a receiver configured to receive a trigger transmitted from a vehicle exterior device in response to occurrence of a predetermined event to a user who is outside of the vehicle. The driving controller is configured to cause the vehicle to automatically travel to a boarding position of the user in response to the reception of the trigger by the receiver.

### CROSS-REFERENCE TO RELATED APPLICATION

Priority is claimed on Japanese Patent Application No. 2019-045101, filed Mar. 12, 2019, the content of which is incorporated herein by reference.

### BACKGROUND

### Field of the Invention

The present invention relates to a vehicle control system, a vehicle control method, and a storage medium.

### Description of Related Art

In recent years, studies of automated vehicle control have been conducted. In relation to these, a technology for automatically returning a vehicle from a parking lot is known (for example, see Japanese Unexamined Patent Application, First Publication No. 2018-180831).

### SUMMARY

In the technology of the related art, an instruction for a vehicle to return is requested in some cases by operating a smartphone or a smart key at the time of return, and thus convenience is not sufficient.

An aspect of the present invention is devised in view of such circumstances and an objective of the present invention is to provide a vehicle control system, a vehicle control method, and a storage medium capable of improving convenience.

A vehicle control system, a vehicle control method, and a storage medium according to the present invention adopt the following configurations.

(1) According to an aspect of the present invention, a vehicle control system includes: a recognizer configured to recognize a surrounding environment of a vehicle; a driving controller configured to perform at least one of speed control and steering control of the vehicle according to a recognition result of the recognizer; and a receiver configured to receive a trigger transmitted from a vehicle exterior device in response to occurrence of a predetermined event to a user who is outside of the vehicle. The driving controller is configured to cause the vehicle to automatically travel to a boarding position of the user in response to the reception of the trigger by the receiver.

(2) In the vehicle control system according to the aspect (1), the trigger may include one or more triggers. The driving controller may cause the vehicle to automatically travel to the boarding position of the user when the receiver receives all of the triggers in response to the occurrence of the predetermined event.

(3) The vehicle control system according to the aspect (2) may further include an air conditioning controller configured to control an air conditioning device of the vehicle. The air conditioning controller may start an operation of the air conditioning device when the receiver receives a first trigger.

(4) In the vehicle control system according to any one of the aspects (1) to (3), the driving controller may cause the vehicle to automatically travel to the boarding position of the user according to a tendency of a time necessary for the user to board the vehicle from the reception of the trigger by the receiver.

(5) The vehicle control system according to any one of the aspects (1) to (4) may further include a receiver configured to receive a designation of an event in which the trigger is generated by the user.

(6) The vehicle control system according to any one of the aspects (1) to (4) may further include an extractor configured to extract a candidate for an event in which the trigger is generated according to an action of the user; a proposer configured to propose the candidate for the event extracted by the extractor; and a receiver configured to receive a designation of the event by the user.

(7) The vehicle control system according to any one of the aspects (1) to (6) may further include an air conditioning controller configured to control an air conditioning device of the vehicle; and a predictor configured to predict a boarding time of the user according to a timing at which the receiver receives the trigger. The air conditioning controller may start an operation of the air conditioning device such that a comfortable temperature is achieved at the boarding time predicted by the predictor.

(8) The vehicle control system according to any one of the aspects (1) to (7) may further include a congestion information acquirer configured to acquire congestion information related to a way to a destination of the user or congestion information related to a way to the boarding position of the user; and an output controller configured to output various kinds of information to a terminal device owned by the user. The output controller may output information for prompting to change a boarding time of the user to the terminal device when the receiver receives the trigger and congestion is predicted according to the congestion information acquired by the congestion information acquirer.

(9) According to another aspect of the present invention, there is provided a vehicle control method causing a computer: to recognize a surrounding environment of a vehicle; to perform at least one of speed control and steering control of the vehicle according to a recognition result; to receive a trigger transmitted from a vehicle exterior device in response to occurrence of a predetermined event to a user who is outside of the vehicle; and to cause the vehicle to automatically travel to a boarding position of the user in response to the reception of the trigger.

(10) According to still another aspect of the present invention, there is provided a computer-readable non-transitory storage medium that stores a program causing a computer: to recognize a surrounding environment of a vehicle; to perform at least one of speed control and steering control of the vehicle according to a recognition result; to receive a trigger transmitted from a vehicle exterior device in response to occurrence of a predetermined event to a user who is outside of the vehicle; and to cause the vehicle to automatically travel to a boarding position of the user in response to the reception of the trigger.

According to the aspects (1) to (10), it is possible to improve convenience.

According to the aspect (3) and (7), it is possible to improve comfort when an occupant boards a vehicle.

### BRIEF DESCRIPTION OF THE DRAWINGS

FIG. 1 is a diagram showing a configuration of a vehicle control system in which a vehicle control device is used according to a first embodiment.

FIG. 2 is a diagram showing a functional configuration of first and second controllers.

FIG. 3 is a diagram showing an example of a boarding event and a vehicle exterior device.

FIG. 4 is a diagram schematically showing a scenario in which an autonomous parking event is performed.

FIG. 5 is a diagram showing an example of a configuration of a parking lot management device.

FIG. 6 is a diagram showing an example of content of trigger information.

FIG. 7 is a flowchart showing a flow of a series of autonomous parking event processes related to a return according to the first embodiment.

FIG. 8 is a diagram showing a configuration of a vehicle control system according to a second embodiment.

FIG. 9 is a diagram showing an example of content of trigger history information.

FIG. 10 is a diagram showing an example of a functional configuration of a terminal device.

FIG. 11 is a diagram showing an example of an execution screen of a vehicle cooperation application.

FIG. 12 is a diagram showing another example of an execution screen of a vehicle cooperation application.

FIG. 13 is a flowchart showing a flow of a series of start trigger addition processes according to the second embodiment.

FIG. 14 is a diagram showing a configuration of a vehicle control system according to a third embodiment.

FIG. 15 is a diagram showing another example of an execution screen of a vehicle cooperation application.

FIG. 16 is a flowchart showing a flow of a series of start trigger addition processes according to the third embodiment.

FIG. 17 is a diagram showing an example of a hardware configuration of an automated driving control device according to an embodiment.

### DESCRIPTION OF EMBODIMENTS

### First Embodiment

Hereinafter, a first embodiment of a vehicle control system, a vehicle control method, and a storage medium according to the present invention will be described with reference to the drawings. Hereinafter, a case in which laws and regulations for left-hand traffic are applied will be described. However, when laws and regulations for right-hand traffic are applied, the left and right may be reversed.

### Overall Configuration

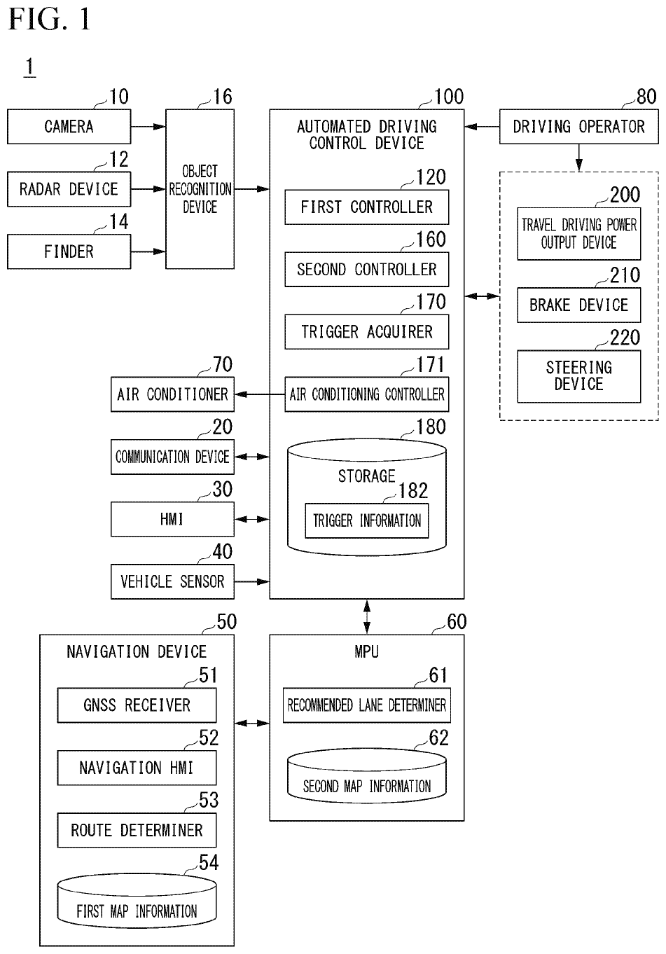

FIG. 1 is a diagram showing a configuration of a vehicle control system 1 in which a vehicle control device is used according to a first embodiment. A vehicle in which the vehicle control system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle control system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, an air conditioner 70, a driving operator 80, an automated driving control device 100, a travel driving power output device 200, a brake device 210, and a steering device 220. The devices and units are connected to one another via a multiplex communication line such as a controller area network (CAN) communication line, a serial communication line, or a wireless communication network. The configuration shown in FIG. 1 is merely exemplary, a part of the configuration may be omitted, and another configuration may be further added.

The camera 10 is, for example, a digital camera that uses a solid-state image sensor such as a charged coupled device (CCD) or a complementary metal oxide semiconductor (CMOS). The camera 10 is mounted on any portion of a vehicle in which the vehicle control system 1 is mounted (hereinafter referred to as an own vehicle M). For example, the camera 10 repeatedly images the surroundings of the own vehicle M periodically. The camera 10 may be a stereo camera.

The radar device 12 radiates radio waves such as millimeter waves to the surroundings of the own vehicle M and detects radio waves (reflected waves) reflected from an object to detect at least a position (a distance and an azimuth) of the object. The radar device 12 is mounted on any portion of the own vehicle M. The radar device 12 may detect a position and a speed of an object in conformity with a frequency modulated continuous wave (FM-CW) scheme.

The finder 14 is a light detection and ranging (LIDAR) finder. The finder 14 radiates light to the surroundings of the own vehicle M and measures scattered light. The finder 14 detects a distance to a target based on a time from light emission to light reception. The radiated light is, for example, pulsed laser light. The finder 14 is mounted on any portions of the own vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control device 100. The object recognition device 16 may output detection results of the camera 10, the radar device 12, and the finder 14 to the automated driving control device 100 without any change. The object recognition device 16 may be excluded from the vehicle control system 1.

The communication device 20 communicates with other vehicles around the own vehicle M using, for example, a cellular network, a Wi-Fi network, Bluetooth (registered trademark), dedicated short range communication (DSRC) or the like or communicates with a parking lot management device (to be described below) or various server devices.

The HMI 30 presents various types of information to an occupant P of the own vehicle M and receives input operations by the occupants. For example, the HMI 30 includes various display devices, speakers, buzzers, touch panels, switches, and keys.

The vehicle sensor 40 includes a vehicle speed sensor that detects a speed of the own vehicle M, an acceleration sensor that detects acceleration, a yaw rate sensor that detects angular velocity around a vertical axis, and an azimuth sensor that detects a direction of the own vehicle M.

The navigation device 50 includes, for example, a global navigation satellite system (GNSS) receiver 51, a navigation HMI 52, and a route determiner 53. The navigation device 50 retains first map information 54 in a storage device such as a hard disk drive (HDD) or a flash memory. The GNSS receiver 51 specifies a position of the own vehicle M based on signals received from GNSS satellites. The position of the own vehicle M may be specified or complemented by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 determines, for example, a route from a position of the own vehicle M specified by the GNSS receiver 51 (or any input position) to a destination input by an occupant using the navigation HMI 52 (hereinafter referred to as a route on a map) with reference to the first map information 54. The first map information 54 is, for example, information in which a road shape is expressed by links indicating roads and nodes connected by the links. The first map information 54 may include curvatures of roads and point of interest (POI) information.

The route on the map is output to the MPU 60. The navigation device 50 may perform route guidance using the navigation HMI 52 based on the route on the map. The navigation device 50 may be realized by, for example, a function of a terminal device (hereinafter referred to as a terminal device 500) such as a smartphone or a tablet terminal possessed by an occupant. The navigation device 50 may transmit a present position and a destination to a navigation server via the communication device 20 to acquire the same route as the route on the map from the navigation server.

The MPU 60 includes, for example, a recommended lane determiner 61 and retains second map information 62 in a storage device such as an HDD or a flash memory. The recommended lane determiner 61 divides the route on the map provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left. When there is a branching location in the route on the map, the recommended lane determiner 61 determines a recommended lane so that the own vehicle M can travel in a reasonable route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The second map information 62 may be updated frequently by communicating with another device using the communication device 20.

The air conditioner 70 adjusts an environment of vehicle interior by adjusting an air state in the vehicle interior of the own vehicle M. An operation of the air conditioner 70 is controlled by the automated driving control device 100. For example, an operation of the air conditioner 70 is controlled to a cooling operation, a heating operation, a maintenance operation, an outside temperature maintenance operation, or a stopping operation by the automated driving control device 100. The maintenance operation is an operation of maintaining a temperature of the vehicle interior of the own vehicle M and the outside temperature maintenance operation is an operation of matching the temperature of the vehicle interior of the own vehicle M with the outside air. The air conditioner 70 is assumed to include a heater in the description. However, the heater may be separate from the air conditioner 70. In the following description, the vehicle interior of the own vehicle M is simply referred to as a “vehicle interior.” The air conditioner 70 is an example of an “air conditioning device.”

The driving operator 80 includes, for example, an accelerator pedal, a brake pedal, a shift lever, a steering wheel, a heteromorphic steering wheel, a joystick, and other operators. A sensor that detects whether there is an operation or an operation amount is mounted in the driving operator 80 and a detection result is output to the automated driving control device 100 or some or all of the travel driving power output device 200, the brake device 210, and the steering device 220.

The automated driving control device 100 includes, for example, a first controller 120, a second controller 160, a trigger acquirer 170, an air conditioning controller 171, and a storage 180. Each of the these functional units is realized, for example, by causing a hardware processor such as a central processing unit (CPU) to execute a program (software). Some or all of the constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The program may be stored in advance in a storage device (a storage device including a non-transitory storage medium) such as an HDD or a flash memory of the automated driving control device 100 or may be stored in a storage medium (a non-transitory storage medium) detachably mounted on a DVD, a CD-ROM, or the like so that the storage medium is mounted on a drive device to be installed on the HDD or the flash memory of the automated driving control device 100. The storage 180 stores trigger information 182.

The details of the trigger information 182 will be described later.

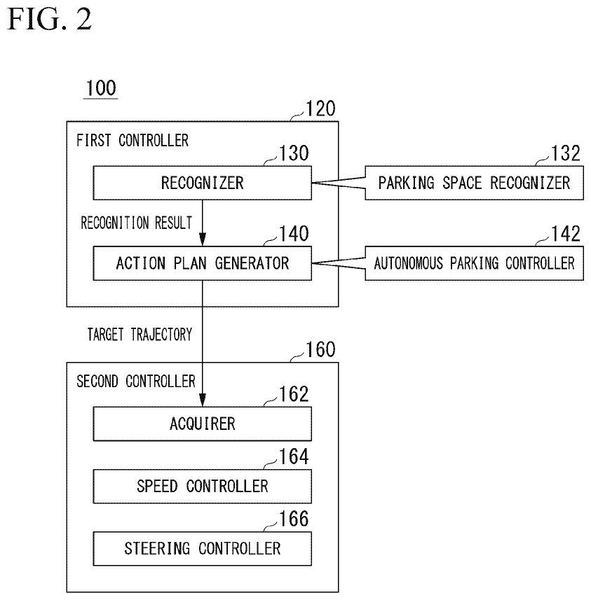

FIG. 2 is a diagram showing a functional configuration of a first controller 120 and a second controller 160. The first controller 120 includes, for example, a recognizer 130 and an action plan generator 140. The first controller 120 realizes, for example, a function by artificial intelligence (AI) and a function by a model given in advance in parallel. For example, a function of “recognizing an intersection” may be realized by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of automated driving is guaranteed.

The recognizer 130 recognizes states such as positions, speeds, or acceleration of objects around the own vehicle M based on information input from the camera 10, the radar device 12, and the finder 14 via the object recognition device 16. For example, the positions of the objects are recognized as positions on the absolute coordinates in which a representative point (a center of gravity, a center of a driving shaft, or the like) of the own vehicle M is the origin and are used for control. The positions of the objects may be represented as representative points such as centers of gravity, corners, or the like of the objects or may be represented as expressed regions. A “state” of an object may include acceleration or jerk of the object or an “action state” (for example, whether a vehicle is changing a lane or is attempting to change the lane).

The recognizer 130 recognizes, for example, a lane in which the own vehicle M is traveling (a travel lane). For example, the recognizer 130 recognizes the travel lane by comparing patterns of road mark lines (for example, arrangement of solid lines and broken lines) obtained from the second map information 62 with patterns of road mark lines around the own vehicle M recognized from images captured by the camera 10. The recognizer 130 may recognize a travel lane by mainly recognizing runway boundaries (road boundaries) including road mark lines or shoulders, curbstones, median strips, and guardrails without being limited to road mark lines. In this recognition, the position of the own vehicle M acquired from the navigation device 50 or a process result by INS may be added. The recognizer 130 recognizes temporary stop lines, obstacles, red signals, toll gates, and other road events.

The recognizer 130 recognizes a position or a posture of the own vehicle M with respect to the travel lane when the recognizer 130 recognizes the travel lane. For example, the recognizer 130 may recognize a deviation from the middle of a lane of a standard point of the own vehicle M and an angle formed with a line extending along the middle of a lane in the movement direction of the own vehicle M as a relative position and posture of the own vehicle M to the travel lane. Instead of this, the recognizer 130 may recognize a position or the like of the standard point of the own vehicle M with respect to a side end portion (a road mark line or a road boundary) of any travel lane as the relative position of the own vehicle M to the travel lane.

The recognizer 130 includes a parking space recognizer 132 that is activated in an autonomous parking event to be described below. The details of the function of the parking space recognizer 132 will be described later.

The action plan generator 140 generates a target trajectory along which the own vehicle M travels in future automatically (irrespective of an operation of a driver or the like) so that the own vehicle M is traveling along a recommended lane determined by the recommended lane determiner 61 and can handle a surrounding situation of the own vehicle M in principle. The target trajectory includes, for example, a speed component. For example, the target trajectory is expressed by arranging spots (trajectory points) at which the own vehicle M will arrive in sequence. The trajectory point is a spot at which the own vehicle M will arrive for each predetermined travel distance (for example, about several [m]) in a distance along a road. Apart from the trajectory points, target acceleration and a target speed are generated as parts of the target trajectory for each of predetermined sampling times (for example, about a decimal point of a second). The trajectory point may be a position at which the own vehicle M will arrive at the sampling time for each predetermined sampling time. In this case, information regarding the target acceleration or the target speed is expressed according to an interval between the trajectory points.

The action plan generator 140 may set an automated driving event when the target trajectory is generated. As the automated driving event, there are a constant speed traveling event, a low speed track traveling event, a lane changing event, a branching event, a joining event, a takeover event, an autonomous parking event in which traveling and parking are performed in valet parking through automated driving, and the like. The action plan generator 140 generates the target trajectory in accordance with an activated event. The action plan generator 140 includes an autonomous parking controller 142 that is activated when an autonomous parking event is performed. The details of a function of the autonomous parking controller 142 will be described later.

The second controller 160 controls the travel driving power output device 200, the brake device 210, and the steering device 220 so that the own vehicle M passes along the target trajectory generated by the action plan generator 140 at a scheduled time.

Referring back to FIG. 2, the second controller 160 includes, for example, an acquirer 162, a speed controller 164, and a steering controller 166. The acquirer 162 acquires information regarding the target trajectory (trajectory points) generated by the action plan generator 140 and stores the information in a memory (not shown). The speed controller 164 controls the travel driving power output device 200 or the brake device 210 based on a speed element incidental to the target trajectory stored in the memory. The steering controller 166 controls the steering device 220 in accordance with a curve state of the target trajectory stored in the memory. Processes of the speed controller 164 and the steering controller 166 are realized, for example, by combining feed-forward control and feedback control. For example, the steering controller 166 performs the feed-forward control in accordance with a curvature of a road in front of the own vehicle M and the feedback control based on separation from the target trajectory in combination. A combination of the action plan generator 140 and the second controller 160 is an example of a “driving controller.”

The trigger acquirer 170 acquires (receives) a trigger transmitted by the vehicle exterior device TM in response to occurrence of a boarding event. The boarding event is a predetermined event equivalent to a boarding request for the occupant P outside of the own vehicle M to board the own vehicle M. The automated driving control device 100 and the vehicle exterior device TM communicate with each other via a network NW. The network NW includes, for example, some or all of a wide area network (WAN), a local area network (LAN), the Internet, a dedicated line, a wireless base station, a provider, and the like. The trigger acquirer 170 is an example of a “receiver.”

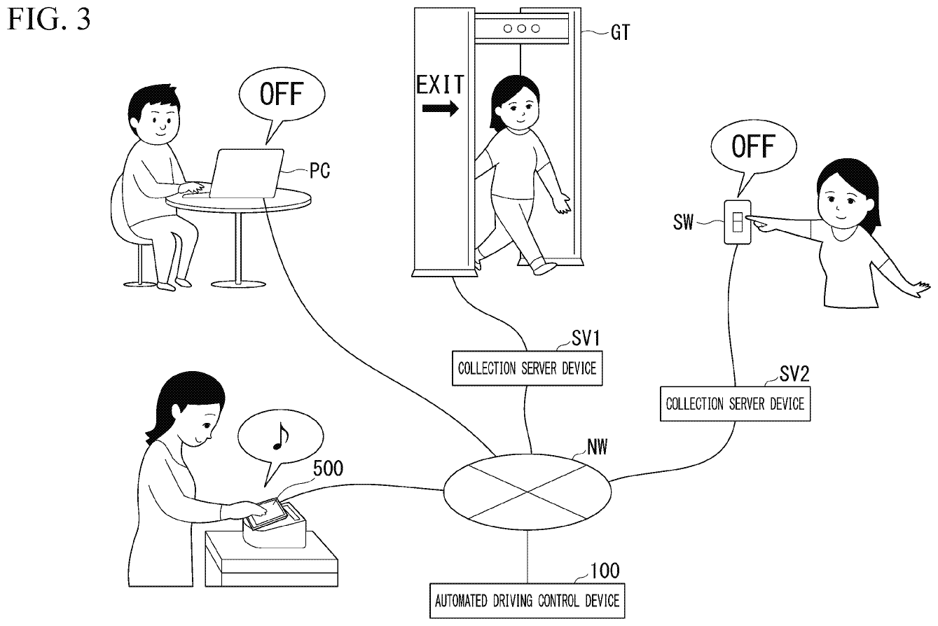

FIG. 3 is a diagram showing an example of a boarding event and the vehicle exterior device TM. The vehicle exterior device TM includes, for example, a personal computer (hereinafter referred to as a personal computer PC) that is used in a company by the occupant P, and a boarding event related to the personal computer PC includes an event in which the occupant P finishes his or her work and turns off the personal computer PC. The personal computer PC generates a trigger in response to starting of a process of turning off power and transmits the generated trigger to the automated driving control device 100 of the occupant P registered in advance.

The vehicle exterior device TM includes, for example, an exit gate GT that is provided in a company of the occupant P or in a theme park in which the occupant P visits and a collection server device SV1 that collects passage information of the exit gate GT, and a boarding event related to the exit gate GT includes passage of the exit gate GT when the occupant P leaves from the company or the theme park. The exit gate GT supplies the collection server device SV1 with information indicating passage of the occupant P with identification information with which a person with a staff identity card of the company or an admission ticket of the theme park can be identified. The collection server device SV1 stores vehicle information in which an owner of a vehicle is associated with an address of the automated driving control device 100 equipped in the vehicle. Thus, when information indicating passage of the occupant P is acquired from the exit gate GT, the collection server device SV1 searches for the vehicle information using the identification information of the occupant P as a searching key while generating a trigger, specifies the address of the automated driving control device 100 equipped in the own vehicle M, and transmits the generated trigger to the automated driving control device 100.

The vehicle exterior device TM includes, for example, an illumination switching device SW that is provided in a home of the occupant P and a collection server device SV2 that collects a state of the illumination switching device SW, and a boarding event related to the illumination switching device SW includes an event of turning off an illumination of a room when the occupant P goes out from his or her home. The illumination switching device SW supplies the collection server device SV2 with information indicating that an operation of turning off an illumination is performed. The collection server device SV2 stores the address of the automated driving control device 100 equipped in the own vehicle M. When the information indicating that the operation of turning off an illumination is performed on the illumination switching device SW is acquired, the collection server device SV2 generates a trigger and transmits the generated trigger to the automated driving control device 100. The collection server device SV2 is realized by, for example, a home energy management system (HEMS) server device. In this case, the illumination switching device SW may be an HEMS device other than an illumination.

The vehicle exterior device TM includes, for example, the terminal device 500 owned by the occupant P, and a boarding event related to the terminal device 500 include settlement performed with an electronic money by the occupant P using the terminal device 500. In the terminal device 500, the address of the automated driving control device 100 equipped in the own vehicle M is stored. The terminal device 500 generates a trigger in response to settlement with electronic money and transmits the generated trigger to the automated driving control device 100.

In the following description, when the personal computer PC, the exit gate GT, the illumination switching device SW, and the terminal device 500 are not distinguished from each other, the personal computer PC, the exit gate GT, the illumination switching device SW, and the terminal device 500 are simply referred to as the vehicle exterior device TM. The above-described vehicle exterior device TM is merely an exemplary example and the present invention is not limited thereto.

The automated driving control device 100 may acquire a trigger directly from the vehicle exterior device TM via the network NW or may acquire a trigger via a sever device collecting triggers which are transmitted to the automated driving control device 100. For example, a trigger supplied by the vehicle exterior device TM may be collected by a server device equipped in a company providing a service related to the trigger and the trigger may be supplied to the automated driving control device 100 of the own vehicle M owned by an owner using the service. The automated driving control device 100 can recognize a type of transmitted trigger (for example, the vehicle exterior device TM providing the trigger). For example, a trigger transmitted from the vehicle exterior device TM includes information with which a transmitter (that is, the vehicle exterior device TM) can be identified, and thus the automated driving control device 100 recognizes the vehicle exterior device TM based on the acquired trigger.

Referring back to FIG. 2, the air conditioning controller 171 starts an operation of the air conditioner 70 in response to a trigger acquired by the trigger acquirer 170. Hereinafter, the air conditioning controller 171 adjusts a vehicle interior environment by controlling the air conditioner 70 such that a temperature inside the own vehicle M becomes an appropriate temperature based on an outside temperature detected by an exterior air sensor (not shown) included in the own vehicle M. The controlling of the air conditioner 70 such that a temperature inside the own vehicle M becomes an appropriate temperature is, for example, controlling of a temperature inside the own vehicle M to a higher temperature through a heating operation when an outside temperature is lower than a predetermined temperature, and is controlling of a temperature inside the own vehicle M to a lower temperature through a cooling operation when the outside temperature is higher than the predetermined temperature.

The travel driving power output device 200 outputs a travel driving force (torque) for traveling the vehicle to a driving wheel. The travel driving power output device 200 includes, for example, a combination of an internal combustion engine, an electric motor and a transmission, and an electronic controller (ECU) controlling these units. The ECU controls the foregoing configuration in accordance with information input from the second controller 160 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor.

The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

### Autonomous Parking Event: at Time of Entrance

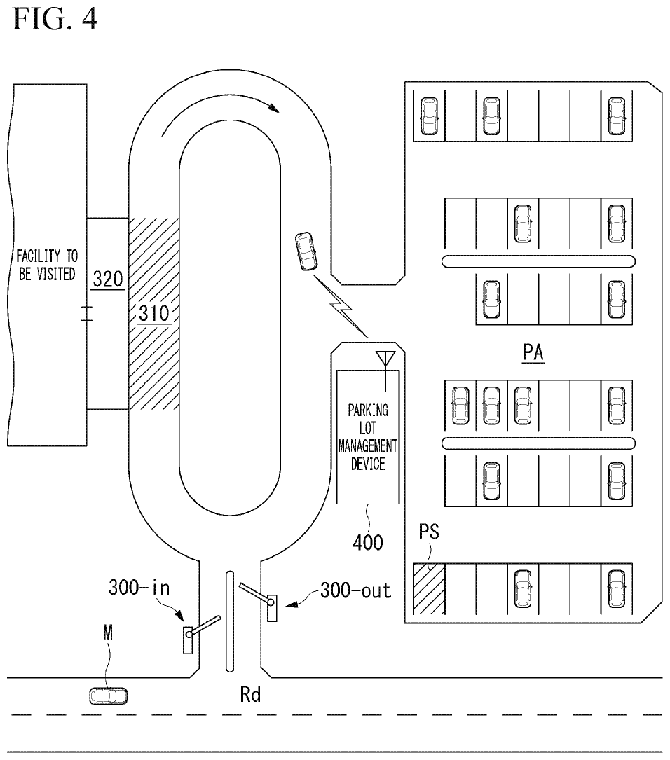

For example, the autonomous parking controller 142 parks the own vehicle M in a parking space based on information acquired from a parking lot management device 400 through the communication device 20. FIG. 4 is a diagram schematically showing a scenario in which an autonomous parking event is performed. Gates 300-in and 300-out are provided on a route from a road Rd to a facility to be visited. The own vehicle M passes through the gate 300-in through manual driving or automated driving and moves to a stopping area 310. The stopping area 310 faces a boarding area 320 connected to the facility to be visited. In the boarding area 320, an eave for avoiding rain and snow is provided in the stopping area 310.

After an occupant gets out of a vehicle in the stopping area 310, the own vehicle M performs automated driving and starts an autonomous parking event for moving to a parking space PS in a parking area PA. The details of a trigger to start the autonomous parking event related to an entrance will be described later. When the autonomous parking event starts, the autonomous parking controller 142 controls the communication device 20 such that a parking request is transmitted to the parking lot management device 400. Then, the own vehicle M moves in accordance with guidance of the parking lot management device 400 or moves while performing sensing by itself from the stopping area 310 to the parking area PA.

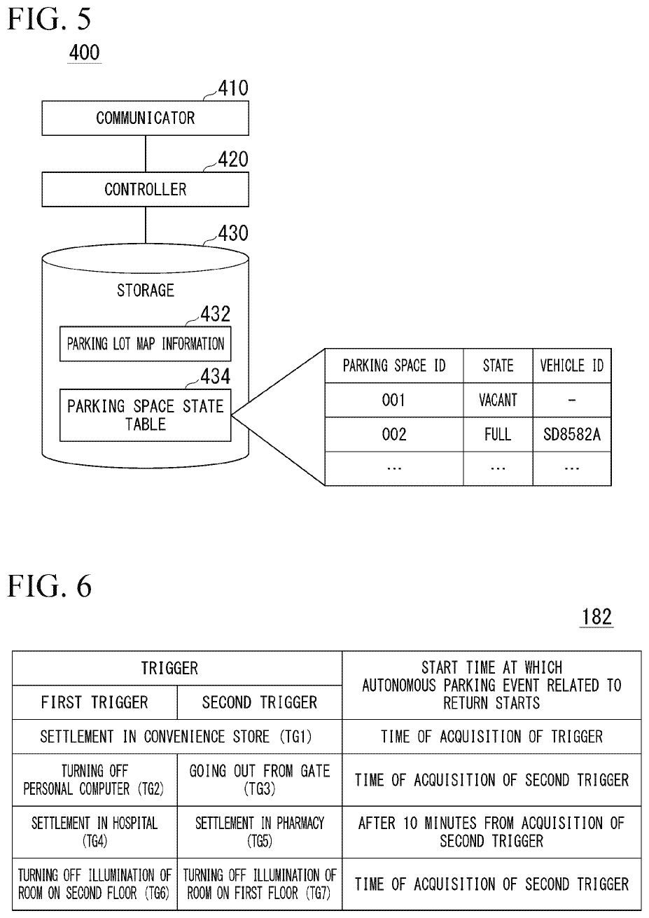

FIG. 5 is a diagram showing an example of a configuration of the parking lot management device 400. The parking lot management device 400 includes, for example, a communicator 410, a controller 420, and a storage 430. The storage 430 stores information such as parking lot map information 432 and a parking space state table 434.

The communicator 410 communicates with the own vehicle M and other vehicles wirelessly. The controller 420 guides a vehicle to the parking space PS based on information acquired by the communicator 410 and information stored in the storage 430. The parking lot map information 432 is information that geometrically represents a structure of the parking area PA. The parking lot map information 432 includes coordinates of each parking space PS. In the parking space state table 434, for example, a state which indicates a vacant state and a full (parking) state and a vehicle ID which is identification information of a vehicle parked in the case of the full state are associated with a parking space ID which is identification information of the parking space PS.

When the communicator 410 receives a parking request from a vehicle, the controller 420 extracts the parking space PS of which a state is a vacant state with reference to the parking space state table 434, acquires a position of the extracted parking space PS from the parking lot map information 432, and transmits a suitable route to the acquired position of the parking space PS to the vehicle through the communicator 410. The controller 420 instructs a specific vehicle to stop or move slowly, as necessary, based on a positional relation between a plurality of vehicles so that the vehicles do not simultaneously move to the same position.

In a vehicle receiving the route (hereinafter, assumed to be the own vehicle M), the autonomous parking controller 142 generates a target trajectory based on the route. When the own vehicle M approaches the parking space PS which is a target, the parking space recognizer 132 recognizes parking frame lines or the like marking the parking space PS, recognizes a detailed position of the parking space PS, and supplies the detailed position of the parking space PS to the autonomous parking controller 142. The autonomous parking controller 142 receives the detailed position of the parking space PS, corrects the target trajectory, and parks the own vehicle M in the parking space PS.

### Autonomous Parking Event: Time of Return

The autonomous parking controller 142 and the communication device 20 are maintained in an operation state even while the own vehicle M is parked. For example, when the communication device 20 receives a pickup request from the terminal device 500 of an occupant, the autonomous parking controller 142 activates a system of the own vehicle M and causes the own vehicle M to move to the stopping area 310. At this time, the autonomous parking controller 142 controls the communication device 20 such that a launch request is transmitted to the parking lot management device 400. The controller 420 of the parking lot management device 400 instructs a specific vehicle to stop or move slowly, as necessary, based on a positional relation between a plurality of vehicles so that the vehicles do not simultaneously moves to the same position, as in the time of entrance. When the own vehicle M is caused to move to the stopping area 310 and picks up the occupant, the autonomous parking controller 142 stops the operation. Thereafter, manual driving or automated driving by another functional unit starts.

The present invention is not limited to the above description, and the autonomous parking controller 142 may find an empty parking space by itself based on a detection result by the camera 10, the radar device 12, the finder 14, or the object recognition device 16 irrespective of communication and may cause the own vehicle M to park in the found parking space.

### Start Trigger of Autonomous Parking Event Related to Return

When a trigger is acquired by the trigger acquirer 170, the autonomous parking controller 142 starts an autonomous parking event related to a return based on the trigger information 182. FIG. 6 is a diagram showing an example of content of the trigger information 182. The trigger information 182 is information in which one or more triggers are associated with a start time of the autonomous parking event related to a return (hereinafter simply referred to as a “start time”). Hereinafter, in the trigger information 182, one trigger or two triggers are assumed to be associated with a start time. When two triggers are associated, a trigger first acquired by the trigger acquirer 170 is referred to as a “first trigger” and a trigger acquired after the first trigger is referred to as a “second trigger.”

The trigger information 182 is generated in association with, for example, a trigger and a start time designated in advance by the occupant P. For example, the occupant P designates a trigger and a start time at which an autonomous parking event related to a return is started with a trigger by using a vehicle cooperation application for designating a boarding event using the autonomous parking event applied to the return in the terminal device 500 as the start trigger. In this case, the terminal device 500 is an example of a “receiver.”

The automated driving control device 100 may execute the application and the HMI 30 may receive an operation by the occupant P designating a trigger and a start time at which an autonomous parking event related to a return starts by the trigger. In this case, the HMI 30 is an example of a “receiver.”

In FIG. 6, a trigger TG1 acquired from the terminal device 500 in response to settlement with electronic money performed in a convenience store and “the time of acquisition of trigger” which is a start time of the autonomous parking event related to the return are associated with each other. A trigger TG2 which is a first trigger and is acquired from the personal computer PC which has been turned off, a trigger TG3 which is a second trigger and is acquired from the exit gate GT recognizing exit of the occupant P, and “the time of acquisition of the second trigger” which is a start time are associated with each other. A trigger TG4 which is the first trigger and is acquired from the terminal device 500 in response to settlement with electronic money performed in a hospital, a trigger TG5 which is the second trigger and is acquired from the terminal device 500 in response to settlement with electronic money performed in a pharmacy, and “after 10 minutes from the acquisition of the second trigger” which is a start time are associated with each other. A trigger TG6 which is the first trigger and is acquired from the illumination switching device SW that has turned off an illumination in a room on the second floor, a trigger TG7 which is the second trigger and is acquired from the illumination switching device SW that has turned off an illumination of a room on the first floor, and “the time of acquisition of the second trigger” which is a start time are associated with each other.

As shown in FIG. 6, the start time may be, for example, the time of acquisition of a trigger or a time at which a predetermined time has passed from acquisition of a trigger. The automated driving control device 100 may include a predictor that predicts a start time associated with a designated trigger based on a tendency of a time at which the occupant P boards the own vehicle M after the autonomous parking event related to a return is executed by the designated trigger. The tendency of the time at which the occupant P boards the own vehicle M is, for example, a tendency for the occupant P to board immediately after the trigger acquirer 170 acquires the trigger or a tendency for the occupant P to board after the trigger acquirer 170 acquires the trigger and several minutes have passed. In this case, the predictor may associate a predicted start time with a trigger and generate (update) the trigger information 182.

When a plurality of triggers are associated with the start time, the air conditioning controller 171 may start an operation of the air conditioner 70 at a timing at which the trigger acquirer 170 acquires the first trigger. Thus, the air conditioning controller 171 adjusts the temperature inside the own vehicle M at the time of the occupant P boarding the own vehicle M to an appropriate temperature, and thus can improve comfort at the time of the occupant P boarding the own vehicle M. The air conditioning controller 171 may operate the air conditioner 70 in accordance with a boarding time of the occupant P predicted by the predictor. Thus, the air conditioning controller 171 can improve comfort at the time of the occupant P boarding the own vehicle M at a more appropriate timing.

### Operation Flow

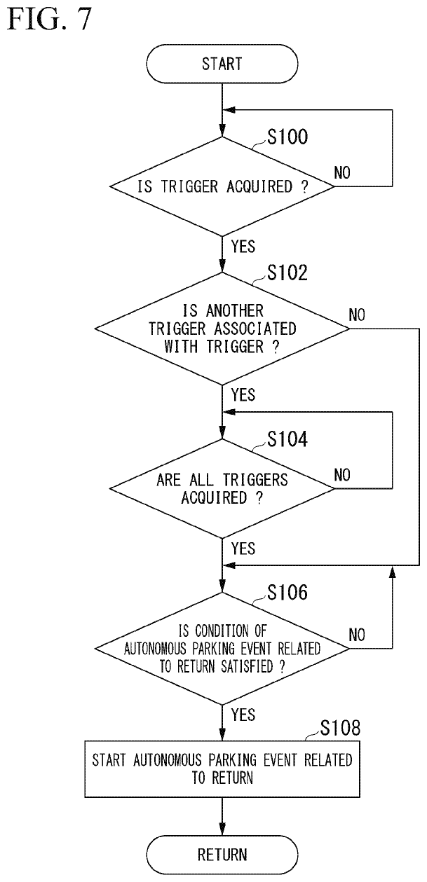

FIG. 7 is a flowchart showing a flow of a series of autonomous parking event processes related to a return according to the first embodiment. First, the trigger acquirer 170 determines whether a trigger is acquired from the vehicle exterior device TM (step S100). The trigger acquirer 170 waits until the trigger is acquired from the vehicle exterior device TM. When it is determined that the trigger acquirer 170 acquires the first trigger, the air conditioning controller 171 determines whether another trigger is associated with the acquired trigger (that is, the acquired trigger is the first trigger) based on the trigger information 182 (step S102). When it is determined that the other trigger is associated with the acquired trigger, the autonomous parking controller 142 determines whether the trigger acquirer 170 acquires all the triggers (step S104). The autonomous parking controller 142 waits until it is determined that the trigger acquirer 170 acquires all the triggers. When it is determined that the trigger acquirer 170 acquires all the triggers, the autonomous parking controller 142 starts the autonomous parking event related to the return at the start time associated with the trigger based on the trigger information 182 (step S108).

### Summary of First Embodiment

As described above, the automated driving control device 100 according to the embodiment includes the recognizer 130 that recognizes a surrounding environment of the own vehicle M; the driving controller (in the example, the action plan generator 140 and the second controller 160) that automatically performs at least one of speed control and steering control of the own vehicle M based on a recognition result of the recognizer 130; and the trigger acquirer 170 that acquires a trigger transmitted from the vehicle exterior device TM in response to occurrence of a predetermined event (a boarding event) to a user of the own vehicle M. The driving controller causes the own vehicle M to automatically travel to a boarding position of the occupant P in response to the acquisition of the trigger by the trigger acquirer 170. Thus, since the own vehicle M can be caused to pick up the occupant P without an operation being performed by the occupant P, it is possible to improve convenience for the occupant P.

The trigger includes the first trigger and the second trigger transmitted by the vehicle exterior device TM in response to occurrence of an event occurring later than the first trigger. When the trigger acquirer 170 acquires both the first trigger and the second trigger, the driving controller causes the own vehicle M to automatically travel to the boarding position of the occupant P. Thus, since the occupant P can be picked up with higher precision, it is possible to improve convenience for the occupant P.

The automated driving control device 100 according to the embodiment further includes the air conditioning controller 171 that controls the air conditioning device (in the example, the air conditioner 70) of the own vehicle M. The air conditioning controller 171 starts an operation of the air conditioner 70 when the trigger acquirer 170 acquires the first trigger. Thus, the air conditioning controller 171 can start air adjustment inside the own vehicle M at a timing at which a possibility of the occupant P heading for the own vehicle M is high and the occupant P has not yet boarded the own vehicle M and can adjust a temperature inside the own vehicle M to an appropriate temperature at a timing at which the occupant P boards the own vehicle M.

In the automated driving control device 100 according to the embodiment, the driving controller causes the own vehicle M to automatically travel to the boarding position of the occupant P based on a tendency of a time necessary for the occupant P to board the own vehicle M from the acquisition of the trigger by the trigger acquirer 170. Thus, since the occupant P is picked up at an appropriate timing without designating (or updating) a start time of the autonomous parking event related to a return set with the trigger information 182 by the occupant P, it is possible to improve convenience for the occupant P.

### Second Embodiment

Hereinafter, a second embodiment of a vehicle control system, a vehicle control method, and a storage medium according to the present invention will be described with reference to the drawings. In the second embodiment, a process in which the automated driving control device 101 proposes a boarding event for recommending use as a trigger of an autonomous parking event related to a return to the occupant P will be described. The same reference numerals as those of the configurations of the above-described embodiment are given and description thereof will be omitted.

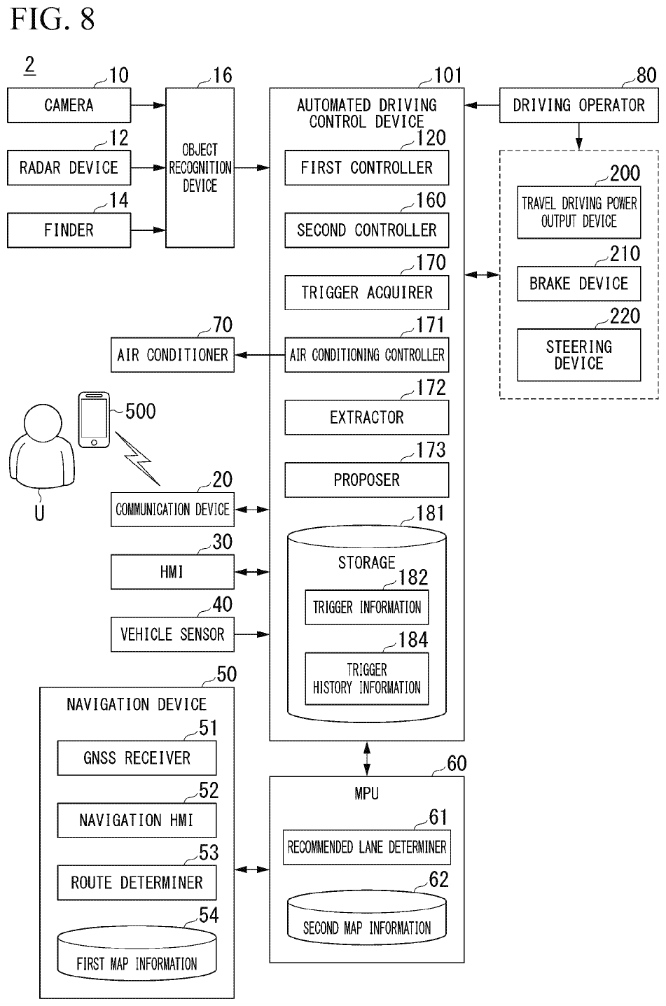

FIG. 8 is a diagram showing a configuration of a vehicle control system 2 according to the second embodiment. The vehicle control system 2 includes, for example, the terminal device 500 in addition to the configuration of the vehicle control system 1 and includes an automated driving control device 101 instead of (or in addition to) the automated driving control device 100 in the configuration of the vehicle control system 1. The configuration shown in FIG. 8 is merely exemplary and a part of the configuration may be omitted or another configuration may further be added.

The automated driving control device 101 includes, for example, the first controller 120, the second controller 160, a trigger acquirer 170, an air conditioning controller 171, an extractor 172, a proposer 173, and a storage 181. Each of the functional units is realized, for example, by causing a hardware processor such as a CPU to execute a program (software). Some or all of the constituent elements may be realized by hardware (a circuit unit including circuitry) such as an LSI, an ASIC, an FPGA, or a GPU or may be realized by software and hardware in cooperation. The program may be stored in advance in a storage device (a storage device including a non-transitory storage medium) such as an HDD or a flash memory of the automated driving control device 101 or may be stored in a storage medium (a non-transitory storage medium) detachably mounted on a DVD, a CD-ROM, or the like so that the storage medium is mounted on a drive device to be installed on the HDD or the flash memory of the automated driving control device 101.

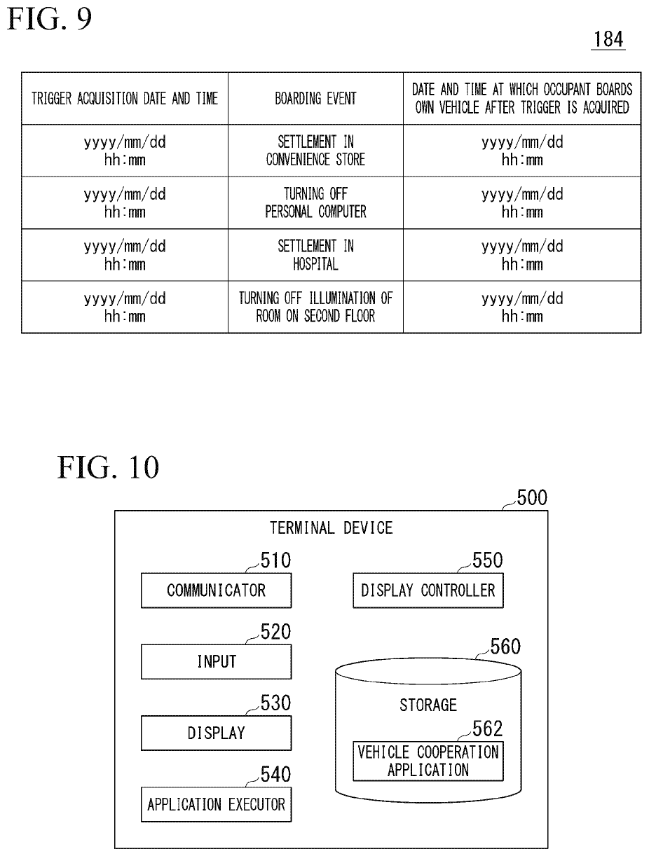

The storage 181 stores the trigger information 182 and trigger history information 184. FIG. 9 is a diagram showing an example of content of the trigger history information 184. The trigger history information 184 is, for example, information in which an acquisition date and time of a trigger acquired by the trigger acquirer 170, a boarding event at the time of generation of the trigger, and a boarding date and time at which the occupant P boards the own vehicle M are associated with each other. The trigger history information 184 is updated, for example, when a trigger is acquired by the trigger acquirer 170.

For example, the extractor 172 extracts candidates for the boarding event based on an action of the occupant P. For example, when a boarding event for generating a trigger not included in the trigger history information 184 based on the trigger history information 184 occurs and a case in which the occupant P boards the own vehicle M within a predetermined time after the occurrence of the boarding event occurs at a predetermined ratio or more, the extractor 172 extracts the boarding event as a boarding event of a start rigger candidate of the autonomous parking event related to a return. The predetermined time is, for example, a time of about several [minutes] to tens of [minutes] and the predetermined ratio is, for example, a ratio of 50 [%] or more. The trigger history information 184 may be stored in the storage 181, may be stored in a device that collects a trigger of the vehicle exterior device TM, or may be stored in a device that collects a trigger transmitted to the automated driving control device 101.

For example, the proposer 173 proposes to use the boarding event extracted by the extractor 172 as a start trigger of the autonomous parking event related to a return. For example, the proposer 173 transmits information indicating the boarding event extracted by the extractor 172 to the terminal device 500.

FIG. 10 is a diagram showing an example of a functional configuration of the terminal device 500. The terminal device 500 includes, for example, a communicator 510, an input 520, a display 530, an application executor 540, a display controller 550, and a storage 560. The communicator 510, the input 520, the display 530, the application executor 540, and the display controller 550 are realized, for example, by causing a hardware processor such as a CPU to execute a program (software). Some or all of the constituent elements may be realized by hardware (a circuit unit including circuitry) such as an LSI, an ASIC, an FPGA, or a GPU or may be realized by software and hardware in cooperation. For example, the above-described program may be stored in advance in a storage device (a storage device including a non-transitory storage medium) such as an HDD or a flash memory included in the terminal device 500 or may be stored in a storage medium (a non-transitory storage medium) detachably mounted on a DVD, a CD-ROM, or the like so that the storage medium is mounted on a drive device to be installed on the storage 560.

For example, the communicator 510 performs communication with the own vehicle M or another external device via a LAN, a WAN, or a network of the Internet.

For example, the input 520 receives an input by a user operating various keys, a button, or the like. The display 530 is, for example, a liquid crystal display (LCD). The input 520 may be integrated with the display 530 as a touch panel.

The application executor 540 is realized by executing a vehicle cooperation application 562 stored in the storage 560. The vehicle cooperation application 562 is, for example, an application program that communicates with the own vehicle M via a network and transmits an entrance instruction or a return instruction in automated travel or response data to a communication state request from the own vehicle M to the own vehicle M. The vehicle cooperation application 562 may acquire information transmitted by the own vehicle M and perform control such that the display 530 is caused to display the information. The vehicle cooperation application 562 may register the terminal device 500 or the occupant P for the own vehicle M or may perform a process related to other vehicle cooperation.

The vehicle cooperation application 562 may be activated or ended through an operation by the occupant P or may be activated or ended by turning on or off the terminal device 500. In this case, the vehicle cooperation application 562 transmits information related to the activation or the end of the application to the own vehicle M after the vehicle cooperation application 562 is activated or before the vehicle cooperation application 562 is ended.

The display controller 550 controls content to be displayed on the display 530 or a timing to be displayed on the display 530. For example, the display controller 550 generates an image for displaying information executed by the application executor 540 on the display 530 and causes the display 530 to display the generated image. The display controller 550 may generate a sound associated with a part or all of the content to be displayed on the display 530 and output the generated sound from a speaker (not shown) of the terminal device. The display controller 550 may cause the display 530 to display an image received from the own vehicle M or may cause the speaker to output the sound received from the own vehicle M.

The storage 560 is realized by, for example, an HDD, a flash memory, an EEPROM, a ROM, a RAM, or the like. In the storage 560, for example, the vehicle cooperation application 562 and other information are stored.

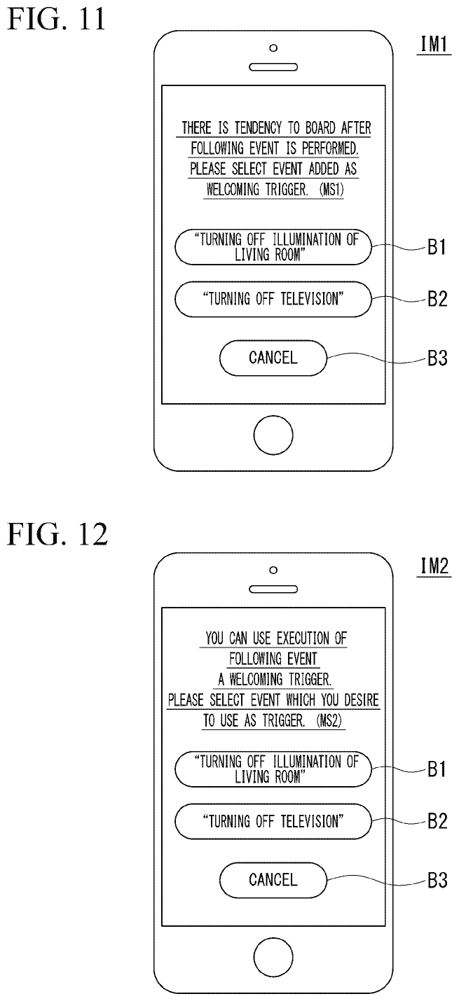

The vehicle cooperation application 562 performs, for example, a process of proposing to use a boarding event as a start trigger of the autonomous parking event related to a return to the occupant P based on information indicating the boarding event received from the proposer 173 and a process of receiving a designation of a boarding event designated by the occupant P in response to the proposal. FIG. 11 is a diagram showing an example of an execution screen IM1 of a vehicle cooperation application 562. The execution screen IM1 is a screen that is displayed on the display 530 by the vehicle cooperation application 562 when information indicating the boarding event is received from the proposer 173. The execution screen IM1 includes, for example, a message MS1 prompting the occupant P to use a boarding event extracted by the extractor 172 as a start trigger of the autonomous parking event related to a return, buttons B1 and B2 for selecting the boarding event with which the trigger extracted by the extractor 172 is generated, and a button B3 for ending a process of selecting a boarding event. The message MS1 is, for example, a message “There is a tendency to board after the following event is performed. Please select an event added as a welcoming trigger.” or the like. As the boarding event with which a trigger is generated, “Turning off illumination of a living room” is associated with the button B1 and “Turning off a television” is associated with the button B2.

The occupant P designates a boarding event serving as a start trigger of the autonomous parking event related to the return, for example, by pressing any button B between the buttons B1 and B2. For example, the terminal device 500 receives the designated boarding event based on an operation performed on the vehicle cooperation application 562. When the boarding event is designated, the terminal device 500 transmits the information indicating the trigger generated with the boarding event to the automated driving control device 101. When the information indicating the trigger is acquired from the terminal device 500, the proposer 173 recognizes that the trigger is used as the start trigger of the autonomous parking event related to the return and adds the trigger to the trigger information 182.

The terminal device 500 may receive a designation of the boarding event without using a proposal of the boarding event from the proposer 173. FIG. 12 is a diagram showing another example of an execution screen IM2 of the vehicle cooperation application 562. The execution screen IM2 is a screen that is displayed on the display 530 by the vehicle cooperation application 562 when a process of designating the boarding event used as the start trigger of the autonomous parking event related to the return by the occupant P is performed. The execution screen IM2 includes, for example, a message MS2 for prompting the occupant P to select the boarding event for generating a trigger used as the start trigger of the autonomous parking event related to the return, buttons B1 and B2 indicating selectable boarding events, and a button B3 for ending the process of selecting a boarding event. The message MS2 is, for example, a message “You can use execution of the following event as a welcoming trigger. Please select an event which you desire to use as trigger.” or the like. For example, the vehicle cooperation application 562 allows the occupant P to select a boarding event by displaying boarding events usable as the start trigger as the buttons B on the execution screen IM2 with reference to the trigger history information 184 stored in the storage 181 of the automated driving control device 101. In the storage 560, boarding events generally used as triggers may be displayed as the buttons B on the execution screen IM2 and the occupant P may be allowed to select a boarding event. In this case, the vehicle cooperation application 562 does not use the trigger history information 184 in a proposal of the boarding event.

### Operation Flow

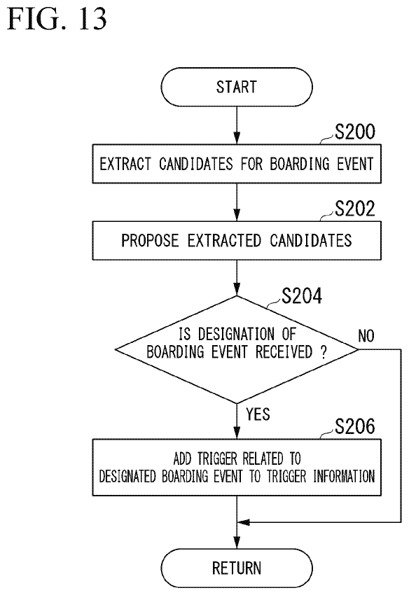

FIG. 13 is a flowchart showing a flow of a series of start trigger addition processes according to the second embodiment. The extractor 172 extracts candidates for the boarding event used as the start trigger of the autonomous parking event related to a return based on the trigger history information 184 (step S200). The proposer 173 proposes the candidates for the boarding event extracted by the extractor 172 to the occupant P (step S202). For example, the proposer 173 proposes the boarding event to the occupant P by transmitting information indicating the candidates for the boarding event extracted by the extractor 172 to the terminal device 500 and presenting the candidates to the occupant P by the vehicle cooperation application 562 executed in the terminal device 500. The proposer 173 determines whether the designation of the boarding event is received in the terminal device 500 (step S204). For example, the proposer 173 determines whether the information indicating the boarding event designated by the terminal device 500 is received. When the proposer 173 determines that the designation of the boarding event is not received, the process ends. When the proposer 173 determines that the designation of the boarding event is received, the proposer 173 adds the trigger generated with the boarding event to the trigger information 182 (step S206).

### Summary of Second Embodiment

As described above, the vehicle control system 2 according to the embodiment includes the extractor 172 that extracts candidates for a boarding event based on an action of the occupant P, the proposer 173 that proposes to use the candidates for the boarding event extracted by the extractor 172 as a start trigger of the autonomous parking event related to a return, and the receiver (in the example, the terminal device 500) that receives a designation of the boarding event by the occupant P or further includes the receiver (in the example, the terminal device 500) that receives a designation of the boarding event by the occupant P. Thus, since the own vehicle M can be caused to pick up the occupant P based on a boarding event appropriate for a desire of the occupant P, it is possible to improve convenience for the occupant P.

### Third Embodiment

Hereinafter, a third embodiment of a vehicle control system, a vehicle control method, and a storage medium according to the present invention will be described with reference to the drawings. In the third embodiment, a process in which an automated driving control device 102 prompts to change a start time of an autonomous parking event related to a return in response to congestion will be described. The same reference numerals as those of the configurations of the above-described embodiment are given and description thereof will be omitted.

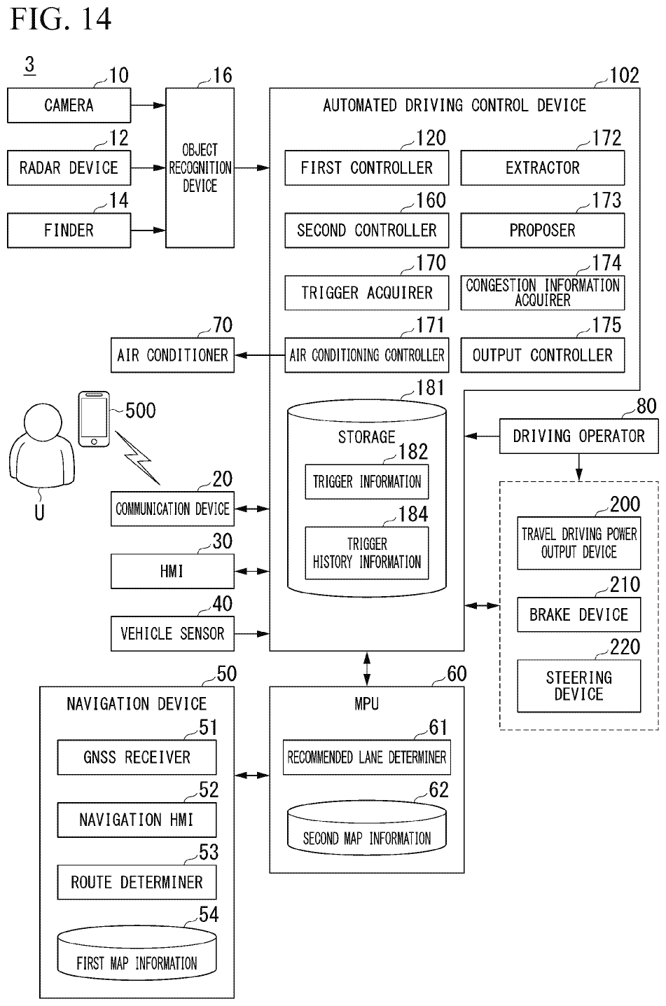

FIG. 14 is a diagram showing a configuration of a vehicle control system 3 according to the third embodiment. The vehicle control system 3 includes, for example, the automated driving control device 102 instead of (or in addition to) the automated driving control device 101 in the configuration of the vehicle control system 2. The configuration shown in FIG. 14 is merely exemplary and a part of the configuration may be omitted or another configuration may further be added.

The automated driving control device 102 includes, for example, the first controller 120, the second controller 160, the trigger acquirer 170, the air conditioning controller 171, the extractor 172, the proposer 173, a congestion information acquirer 174, an output controller 175, and the storage 181.

For example, when the trigger acquirer 170 acquires a start trigger of the autonomous parking event related to a return, the congestion information acquirer 174 acquires congestion information related to a way to a location for which the occupant P heads with the own vehicle M (that is, a destination) in accordance with the boarding event with which the trigger is generated. The congestion information is, for example, information in which a place where congestion occurs is associated with a time at which the congestion occurs in that place or information in which a place where congestion is predicted to occur is associated with a time at which the congestion is predicted to occur in that place. The congestion information is stored in, for example, a server device that collects congestion information of each place and the congestion information acquirer 174 searches the server device using a destination as a searching key to acquire state information.

When the trigger acquirer 170 acquires a trigger and congestion is predicted in a way to a destination of the occupant P based on the congestion information acquired by the congestion information acquirer 174, the output controller 175 outputs information prompting to change a boarding time of the occupant P to the terminal device 500.

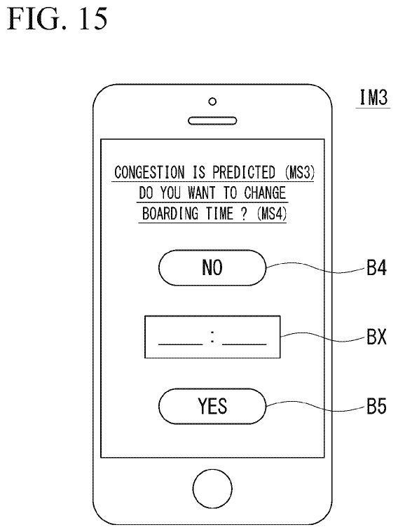

The vehicle cooperation application 562 performs, for example, a process of proposing a change in a boarding time of the occupant P to the occupant P based on information for prompting to change the boarding time of the occupant P received from the output controller 175 and a process of receiving a designation of a boarding time designated by the occupant P in response to a proposal. FIG. 15 is a diagram showing another example of an execution screen IM3 of the vehicle cooperation application 562. The execution screen IM3 is a screen that is displayed on the display 530 by the vehicle cooperation application 562 when the information for prompting to change the boarding time of the occupant P is received from the output controller 175. The execution screen IM3 includes, for example, a message MS3 indicating prediction of congestion in the way to the destination, a message MS4 for prompting the occupant P to change the boarding time, a button B4 for ending the process of changing the boarding time, a box BX for receiving the changed boarding time, and a button B5 for determining the changed boarding time. The message MS3 is, for example, a message “Congestion is predicted” or the like. The message MS4 is, for example, a message “Do you want to change boarding time?” or the like. When the changed boarding time is received in the vehicle cooperation application 562, the autonomous parking controller 142 starts the autonomous parking event related to the return at that boarding time.

### Operation Flow

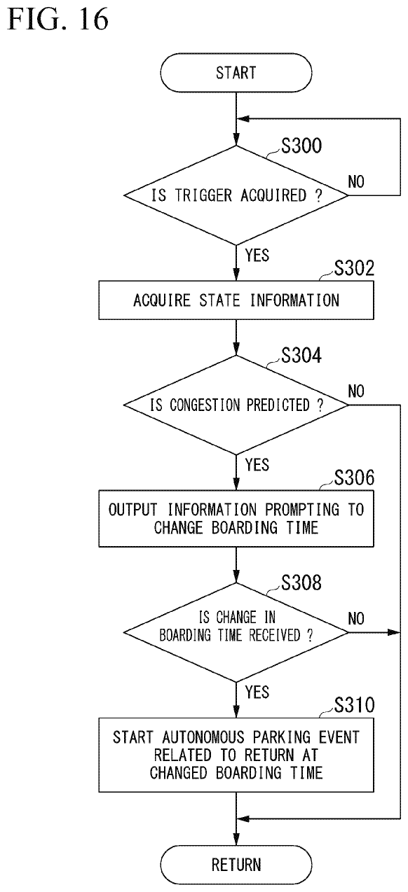

FIG. 16 is a flowchart showing a flow of a series of start trigger addition processes according to the third embodiment. First, the trigger acquirer 170 determines whether to acquire a trigger from the vehicle exterior device TM (step S300). The trigger acquirer 170 waits until the trigger is acquired from the vehicle exterior device TM. The congestion information acquirer 174 acquires congestion information when the trigger acquirer 170 acquires the trigger (step S302). The output controller 175 determines whether the congestion is predicted in the way to the destination of the occupant P based on the congestion information acquired by the congestion information acquirer 174 (step S304). When the output controller 175 determines that no congestion is predicted in the way to the destination of the occupant P, the output controller 175 ends the process. When the congestion is predicted in the way to the destination of the occupant P, the output controller 175 outputs the information for prompting to change the boarding time of the occupant P to the terminal device 500 (step S306). The autonomous parking controller 142 determines whether a change in the boarding time is received in the vehicle cooperation application 562 in response to the output of the information to the terminal device 500 by the output controller 175 (step S308). When the autonomous parking controller 142 determines that the change in the boarding time is not received, the process ends. When the autonomous parking controller 142 determines that the change in the boarding time is received, the autonomous parking event related to the return is started at the changed boarding time (step S310).

### Congestion to Boarding Position

As described above, when the congestion is predicted in the way to the destination of the occupant P, the output controller 175 outputs the information for prompting to change the boarding time of the occupant P to the terminal device 500, but the present invention is not limited thereto. For example, the congestion information acquirer 174 may acquire congestion information related to a way from the parking lot PA to a boarding position (in the example, the boarding area 320) of the occupant P. In this case, when congestion is predicted in the way to the boarding position of the occupant P, the output controller 175 may output information for prompting to change the boarding time of the occupant P to the terminal device 500.

### Summary of Third Embodiment

As described above, the vehicle control system 3 according to the embodiment further includes the congestion information acquirer 174 that acquires the congestion information related to the way to the destination of the occupant P and the output controller 175 that outputs various kinds of information to the terminal device 500 owned by the occupant P. When the trigger acquirer 170 acquires the trigger and the congestion is predicted based on the congestion information acquired by the congestion information acquirer 174, the output controller 175 outputs the information for prompting to change the boarding time of the occupant P to the terminal device 500. Thus, it is possible to improve convenience for the occupant P.

### Hardware Configuration

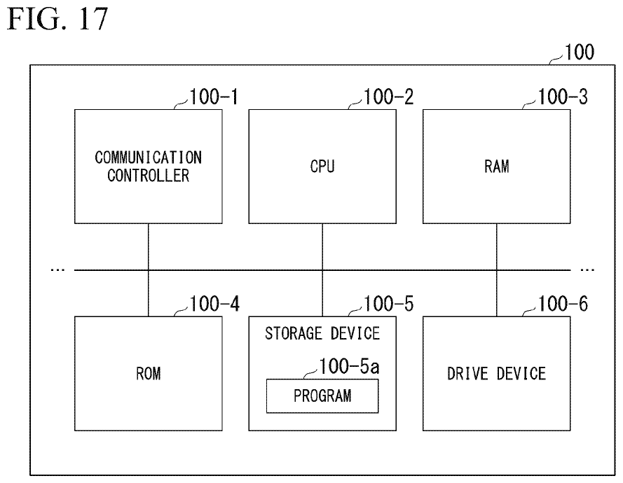

FIG. 17 is a diagram showing an example of a hardware configuration of the automated driving control device 100 according to an embodiment. As shown, the automated driving control device 100 is configured such that a communication controller 100-1, a CPU 100-2, a random access memory (RAM) 100-3 that is used as a working memory, a read-only memory (ROM) 100-4 that stores a boot program or the like, a storage device 100-5 such as a flash memory or a hard disk drive (HDD), a drive device 100-6, and the like are connected to each other via an internal bus or a dedicated communication line. The communication controller 100-1 performs communication with constituent element other than the automated driving control device 100. The storage device 100-5 stores a program 100-5a that is executed by the CPU 100-2. The program is loaded on the RAM 100-3 by a direct memory access (DMA) controller (not shown) to be executed by the CPU 100-2. Thus, some or all of the recognizer 130, the action plan generator 140, and the autonomous parking controller 142 are realized.

The above-described embodiment can be expressed as follows:

the automated driving control device including a storage device that stores a program and a hardware processor, the automated driving control device causing the hardware processor to execute the program stored in the storage device,

to recognize a surrounding environment of a vehicle;

to perform at least one of speed control and steering control of the vehicle based on a recognition result;

to acquire a trigger generated by a vehicle exterior device in response to occurrence of a predetermined event to a user of the vehicle who is outside of the vehicle; and

to cause the vehicle to cause the vehicle to automatically travel to a boarding position of the user in response to the acquisition of the trigger.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control system comprising:
a recognizer configured to recognize a surrounding environment of a vehicle;
a driving controller configured to perform at least one of speed control and steering control of the vehicle according to a recognition result of the recognizer; and
a receiver configured to receive a trigger transmitted from a vehicle exterior device in response to occurrence of a predetermined event to a user who is outside of the vehicle,
wherein the driving controller is configured to cause the vehicle to automatically travel to a boarding position of the user in response to the reception of the trigger by the receiver.

2. The vehicle control system according to claim 1,
wherein the trigger includes one or more triggers, and
wherein the driving controller is configured to cause the vehicle to automatically travel to the boarding position of the user when the receiver receives all of the triggers in response to the occurrence of the predetermined event.

3. The vehicle control system according to claim 2, further comprising:
an air conditioning controller configured to control an air conditioning device of the vehicle,
wherein the air conditioning controller is configured to start an operation of the air conditioning device when the receiver receives a first trigger.

4. The vehicle control system according to claim 1, wherein the driving controller is configured to cause the vehicle to automatically travel to the boarding position of the user according to a tendency of a time necessary for the user to board the vehicle from the reception of the trigger by the receiver.

5. The vehicle control system according to claim 1, further comprising:
a receiver configured to receive a designation of an event in which the trigger is generated by the user.

6. The vehicle control system according to claim 1, further comprising:
an extractor configured to extract a candidate for an event in which the trigger is generated according to an action of the user;
a proposer configured to propose the candidate for the event extracted by the extractor; and
a receiver configured to receive a designation of the event by the user.

7. The vehicle control system according to claim 1, further comprising:
an air conditioning controller configured to control an air conditioning device of the vehicle; and
a predictor configured to predict a boarding time of the user according to a timing at which the receiver receives the trigger,
wherein the air conditioning controller is configured to start an operation of the air conditioning device such that a comfortable temperature is achieved at the boarding time predicted by the predictor.

8. The vehicle control system according to claim 1, further comprising:
a congestion information acquirer configured to acquire congestion information related to a way to a destination of the user or congestion information related to a way to the boarding position of the user; and
an output controller configured to output various kinds of information to a terminal device owned by the user,
wherein the output controller is configured to output information for prompting to change a boarding time of the user to the terminal device when the receiver receives the trigger and congestion is predicted according to the congestion information acquired by the congestion information acquirer.

9. A vehicle control method causing a computer:
to recognize a surrounding environment of a vehicle;
to perform at least one of speed control and steering control of the vehicle according to a recognition result;
to receive a trigger transmitted from a vehicle exterior device in response to occurrence of a predetermined event to a user who is outside of the vehicle; and
to cause the vehicle to automatically travel to a boarding position of the user in response to the reception of the trigger.

10. A computer-readable non-transitory storage medium that stores a program causing a computer:
to recognize a surrounding environment of a vehicle;
to perform at least one of speed control and steering control of the vehicle according to a recognition result;
to receive a trigger transmitted from a vehicle exterior device in response to occurrence of a predetermined event to a user who is outside of the vehicle; and
to cause the vehicle to automatically travel to a boarding position of the user in response to the reception of the trigger.
